(19) United States
(12) Patent Application Publication
(10) Pub. No.: US 2009/0103290 A1
(43) Pub. Date: Apr. 23, 2009

(54) TELESCOPIC AND BENDABLE ELECTRIC TORCH

(76) Inventor: Kou-Ling Liu, Kunshan City (CN)

Correspondence Address: Kou-Ling Liu, 235 Chung - Ho, Box 8-24, Taipei, 235, TW

(21) Appl. No.: 11/874,931

(22) Filed: Oct. 19, 2007

(51) Int. Cl. F21L 4/04

(52) U.S. Cl. 362/197

(57) ABSTRACT

A telescopic and bendable electric torch comprise a hollow handle having a shape like a long rod; the handle being formed with a receiving space; a head having a telescopic section and a bendable section; the telescopic section being formed with a plurality of tubes with one tube being received in another tube so as to form as a telescopic structure; the bendable section being installed at one end of the telescopic section without engaging to the lower cover; the bendable section being a bendable soft tube; a front end of the bendable section being installed with an illuminator; and the illuminator including at least one lamp. A magnetic unit is formed at a front end of the head so as to attract objects in operation. The illuminator includes the lamp, a cover and a seat; the at least one battery is located between the cover and seat.

### FIELD OF THE INVENTION

The present invention relates to electric torches, and particularly to a telescopic and bendable electric torch, which can be prolonged or bended for illuminating a deep place, and moreover, a magnetic unit is installed to the electric torch for finding an object easily.

### BACKGROUND OF THE INVENTION

Generally, the electric torch has only the function of illumination, but the shape and length of the electric torch is fixed. It can not be prolonged or bent. However in many situations, especially in working places, it is necessary to use an electric torch to find an object, while the object is in a deep place, even the place is not so directly in viewing.

Thus, if the electric torch can be prolonged or bended, then above-mentioned problem can be resolved.

Moreover, in some situations, it is necessary to find an object in dark place, such as a screw, or a tiny element, which is lost in working, however at this situation, an electric torch is used, while the user must view the illuminated area for finding the object. However if the electric torch has the ability of attracting the object. Thus the operation will become convenient and easy.

### SUMMARY OF THE INVENTION

Accordingly, the primary object of the present invention is to provide a telescopic and bendable electric torch, which can be prolonged or bended for illuminating a deep place, and moreover, a magnetic unit is installed to the electric torch for finding an object easily.

To achieve above objects, the present invention provides a telescopic and bendable electric torch which comprise a hollow handle having a shape like a long rod; the handle being formed with a receiving space; a head having a telescopic section and a bendable section; the telescopic section being formed with a plurality of tubes with one tube being received in another tube so as to form as a telescopic structure; the bendable section being installed at one end of the telescopic section without engaging to the lower cover; the bendable section being a bendable soft tube; a front end of the bendable section being installed with an illuminator; and the illuminator including at least one lamp. A magnetic unit is formed at a front end of the head so as to attract objects in operation The illuminator includes the lamp, a cover and a seat; the at least one battery is located between the cover and seat. The head is installed with a switch; by switching the switch, the turning on and off of the lamps are controlled. A lower cover has an inner thread and an outer thread; the outer thread of the lower cover is engaged to the inner thread of the handle.

The various objects and advantages of the present invention will be more readily understood from the following detailed description when read in conjunction with the appended drawing.

### BRIEF DESCRIPTION OF THE DRAWINGS

FIG. 1 is an exploded perspective view of the telescopic and bendable electric torch of the present invention.

FIG. 2 is a schematic perspective view of the telescopic and bendable electric torch of the present invention which is in a compression state.

FIG. 3 is a schematic perspective view of the telescopic and bendable electric torch of the present invention which is in an extending state.

FIG. 4 is a schematic cross sectional view showing the compression state of the present invention.

FIG. 5 is a schematic cross sectional view showing the extending state of the present invention.

FIG. 6 is a schematic view showing the use of the present invention which is in an extending state.

FIG. 7 is a schematic view showing the bending operation of the telescopic and bendable electric torch of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

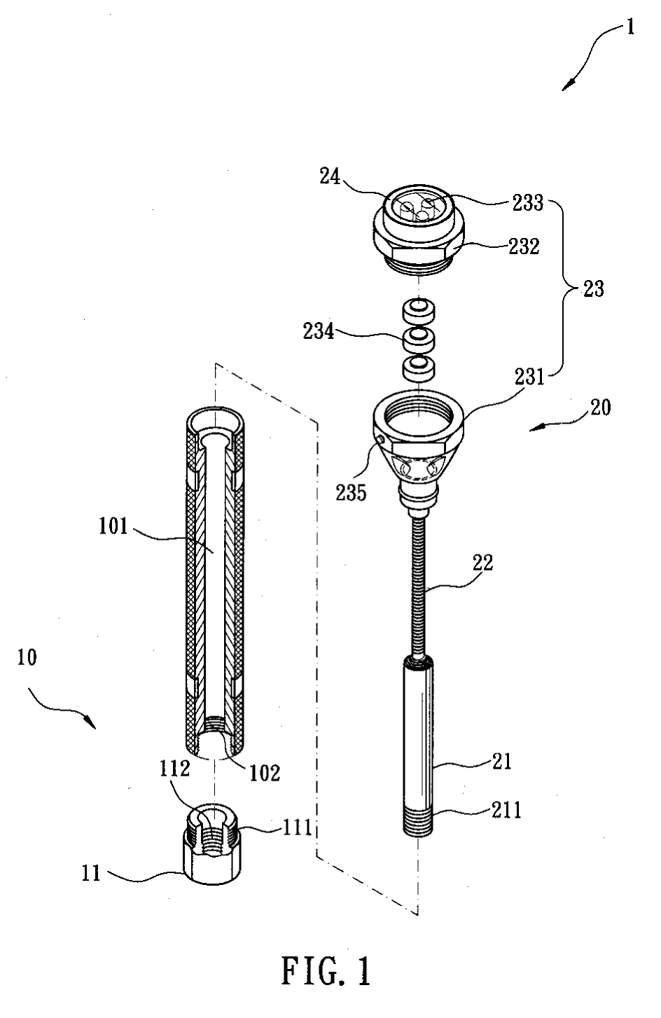

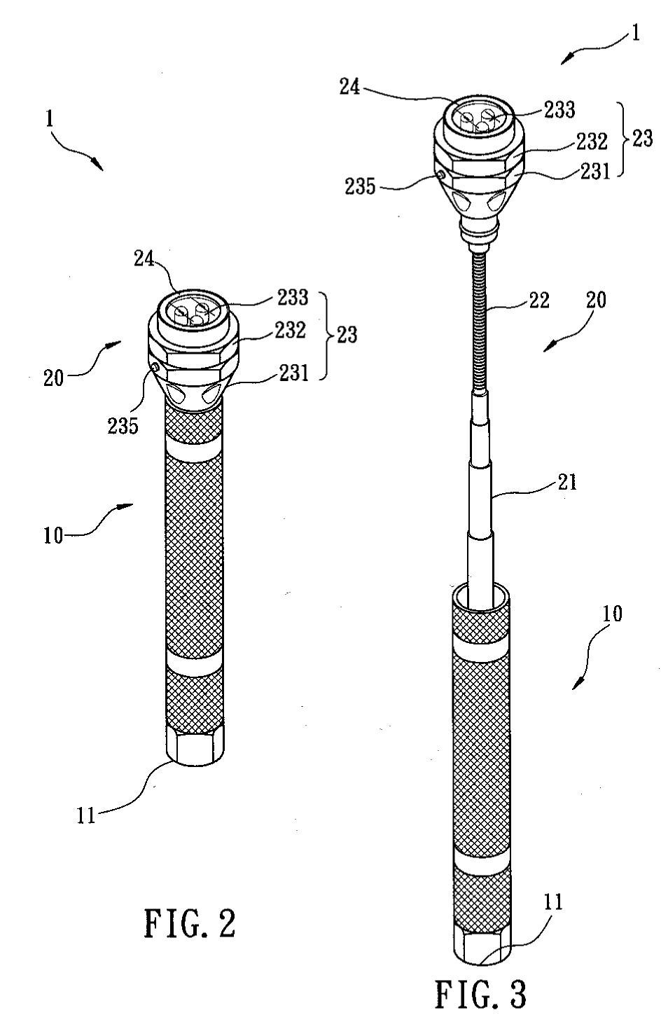

Referring to FIGS. 1 to 5, the telescopic electric torch of the present invention is illustrated. The present invention has the following elements.

A hollow handle 10 has a shape like a long rod. The handle 10 is formed with a receiving space 101. Two ends of the receiving space 101 are opened. A lower end of the receiving space 101 is formed with inner thread 102.

A lower cover 11 has an inner thread 112 and an outer thread 111. The outer thread 111 of the lower cover 11 is engaged to the inner thread 102 of the handle 10.

A head 20 has a telescopic section 21 and a bendable section 22. The telescopic section 21 is formed with a plurality of tubes with one tube being received in another tube so as to form as a telescopic structure. A lower side of the telescopic section 21 is formed with a thread section 211 with outer threads. The thread section 211 serves to engage with the inner thread 112 of the lower cover 11 so that the telescopic section 21 and the head 20 is engaged to the handle 10. The bendable section 22 is installed at one end of the telescopic section 21 without engaging to the lower cover 11. The bendable section 22 is a bendable soft tube. A front end of the bendable section 22 is installed with an illuminator 23. The illuminator 23 includes a seat 231, a cover 232 and a plurality of lamps 233. At least one battery 234 is installed between the seat 231 and the cover 232. The head 20 is installed with a switch 235. By switching the switch 235, the operations of turning on and off of the lamps 233 are controlled. Moreover, a magnetic unit 24 is formed at a front end of the head 20 so as to attract objects in operation.

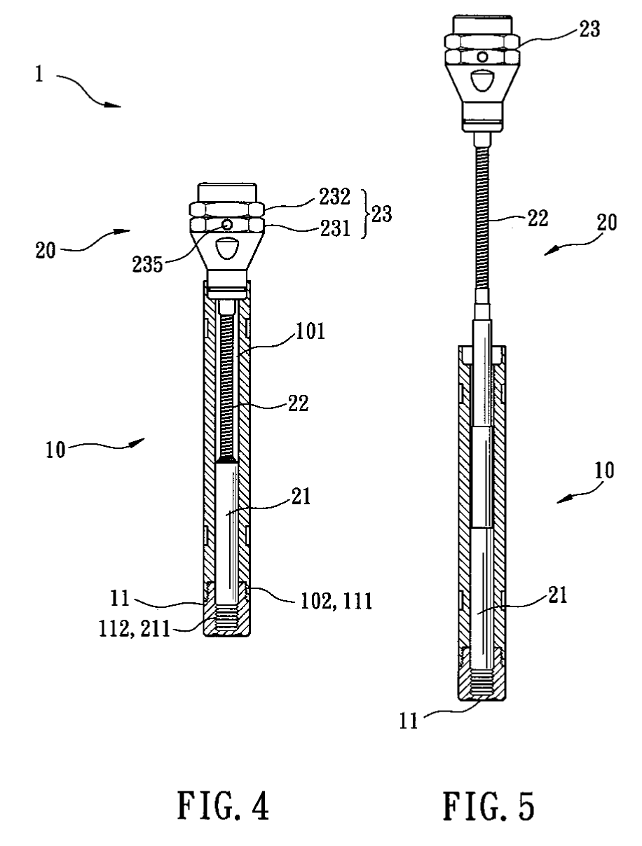

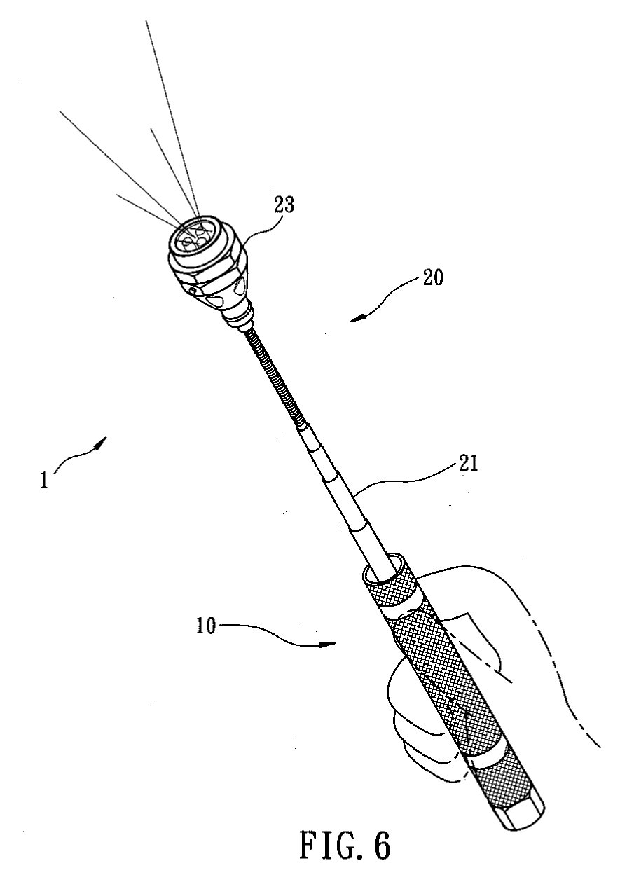

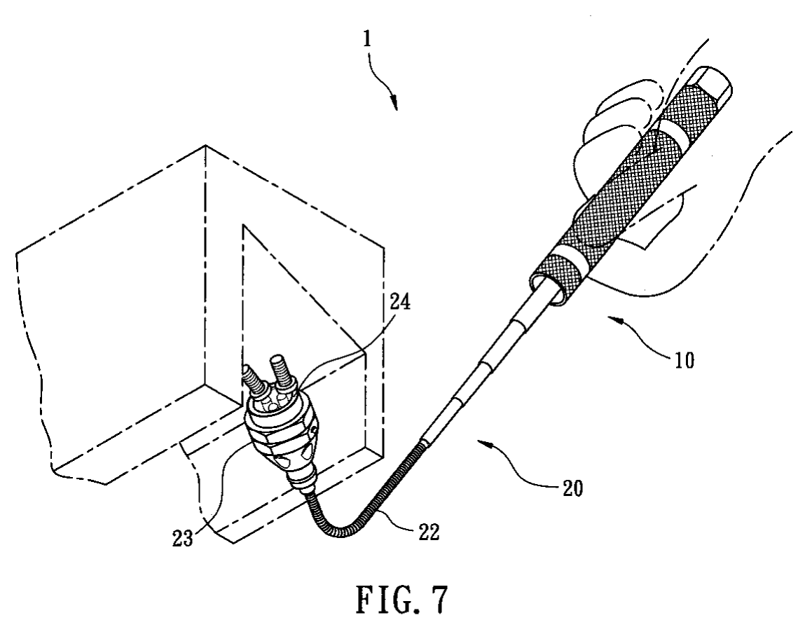

Referring to FIGS. 6 and 7, the use of the present invention is illustrated. In the present invention, the telescopic section 21 of the head 20 can be prolonged or shortened in operation so that the illuminator 23 can move closely to an object for viewing. If it is desired to retract the head 20, it is only necessary to compress the telescopic section 21 (referring to FIG. 4) so as to have a small volume for storage.

Referring to FIG. 7, it is illustrated that the bendable section 22 is adjustable to different orientations so as to change the direction of the illumination. The magnetic unit 24 at the front end of head 20 serves to attract to an object in farther place or to search an object to be found.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A telescopic and bendable electric torch, comprising:
a hollow handle having a shape like a long rod; the handle being formed with a receiving space; and
a head having a telescopic section and a bendable section; the telescopic section being formed with a plurality of tubes with one tube being received in another tube so as to form as a telescopic structure; the bendable section being installed at one end of the telescopic section; the bendable section being a bendable soft tube; a front end of the bendable section being installed with an illuminator; and the illuminator including at least one lamp.

2. The telescopic and bendable electric torch as claimed in claim 1, wherein a magnetic unit is formed at a front end of the head so as to attract objects in operation

3. The telescopic and bendable electric torch as claimed in claim 1, wherein the illuminator includes the lamp, a cover and a seat; the at least one battery is located between the cover and seat.

4. The telescopic and bendable electric torch as claimed in claim 1, wherein the head is installed with a switch; by switching the switch, the turning on and off of the lamps are controlled.

5. The telescopic and bendable electric torch as claimed in claim 1, wherein a lower cover has an inner thread and an outer thread; the outer thread of the lower cover is engaged to the inner thread of the handle.
